(19) United States
(12) Patent Application Publication
(10) Pub. No.: US 2010/0024586 A1
(43) Pub. Date: Feb. 4, 2010

(54) Manual Transmission

(75) Inventor: Olaf Heldmann, Buettelborn (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/307,359

(22) PCT Filed: Jun. 25, 2007
(86) PCT No.: PCT/EP2007/005511

§ 371 Date: Oct. 6, 2009

(30) Foreign Application Priority Data
Jul. 7, 2006 (DE) 10 2006 031 390.9

(51) Int. Cl. F16H 59/04

(52) U.S. Cl. 74/473.36

(57) ABSTRACT

A manual transmission, in particular for an automobile, comprises a transmission housing (25), a drive and a driven shaft, which may be coupled to one another in different transmission ratios, a shifter shaft (1), which is rotatable and axially displaceable along predefined paths between positions corresponding to the different transmission ratios of the manual transmission, as well as at least one pair of guide elements (10, 5), which predefine these paths in a cooperating manner. The first (10) of the two guide elements is attached so that it can move with the shifter shaft (1) and the second (5) is attached to a first flange (26) connected to the transmission housing (25). The first flange (26) is fastened detachably to the transmission housing (25) and is connected to the shifter shaft (1) to form a structural unit.

The present invention relates to a manual transmission, in particular for an automobile, comprising a transmission housing, a drive and a driven shaft, which may be coupled to one another in different transmission ratios, a shifter shaft, which is rotatable and axially displaceable along predefined paths between positions corresponding to the different transmission ratios of the manual transmission, as well as at least one pair of guide elements, which predefine these paths in a cooperating manner. Such a manual transmission is known, for example, from DE 41 10 555 A1.

This known manual transmission has a transmission housing, in which the shifter shaft extends, and the shifter shaft has a shift finger, which engages in a slot of a shift rail to set one of the transmission ratios of the manual transmission by means of the shift rail. A pair of guide elements is formed by a sleeve which is movable with the shifter shaft and by a spring-loaded ball, which is mounted in the transmission housing and engages in a groove formed in the sleeve.

In order to adjust the transmission ratio of the manual transmission, a driver moves the shifter shaft generally with the aid of a gear shift lever mounted in the passenger compartment of the vehicle. The forces which he applies to the gear shift lever, provide him with a haptic acknowledgement relating to the sequence of the shift process. Due to the different transmission designs, the behavior of these forces is generally different from one automobile model to another, which requires the driver to familiarize himself every time he changes from one automobile model to another and initially invokes a feeling of uncertainty. Repairs to the manual transmission can also have the result that the force behavior changes, which may initially bring about a subjective feeling of dissatisfaction with the repair for the driver.

It is the object of the invention to provide a structure for a manual transmission, in which it is at least easier than in conventional manual transmissions to produce a reproducible force behavior during a shift movement.

The object is achieved whereby in a manual transmission of the type specified initially, the first flange is fastened detachably to the transmission housing and is connected to the shifter shaft to form a structural unit. As a result, the possibility is provided for testing out the mobility of the shifter shaft and the cooperation of the guide elements on the structural unit without the guide shaft simultaneously driving a shift movement and if the ensuing forces differ from the predicted values, corrections can optionally be made to the structural unit.

The shifter shaft is preferably guided through the flange bearing the guide element.

The first guide element which is movable with the shifter shaft preferably comprises a tip and the second mounted on the flange comprises a guide contour scanned by the tip. For the same dimensions of the structural unit, such a guide contour can be made larger than in the converse case in which a tip fixed to the housing scans a guide contour connected to the shaft. The larger the guide contour can be made, the smaller is the influence of unavoidable manufacturing inaccuracies of the guide contour on the shift movement.

In order that the mobility of the shifter shaft can be influenced easily, the spring force of a spring which presses the guide elements toward one another is preferably adjustable.

The structural unit is preferably anchored on the transmission housing by fastening the first flange on a complementary second flange forming a component of the transmission housing. At the same time, one of the flanges expediently has a centering body, which engages in a complementary recess of the respectively other flange in order to position the structural unit in relation to the transmission housing.

In particular, the centering body may be part of the first flange, in which case the second guide element is expediently attached to the centering body.

Further features and advantages of the invention are obtained from the following description of an exemplary embodiment with reference to the appended figures. In the figures:

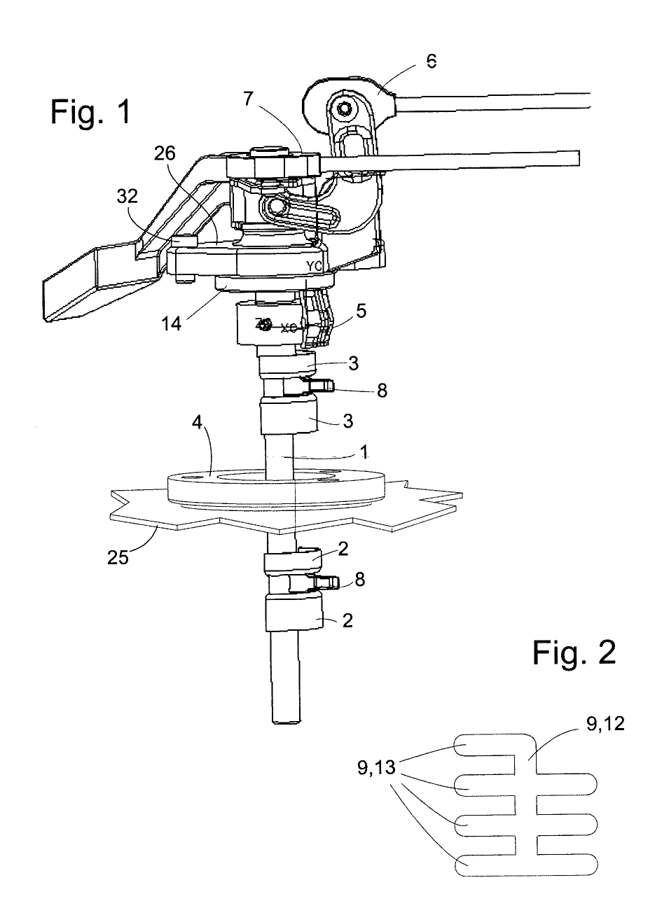

FIG. 1 shows a section through an assembly comprising shifter shaft, flange, and guide elements, partially inserted into a transmission housing depicted fragmentarily;

FIG. 2 shows an unrolling of grooves formed in a sleeve of the assembly;

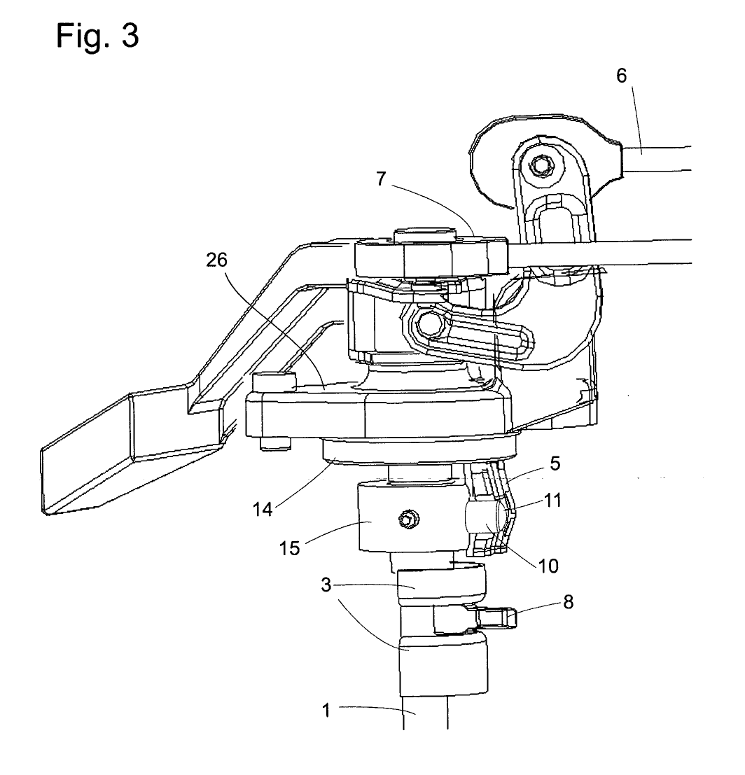

FIG. 3 shows an enlarged part of the assembly from FIG. 1 in perspective view;

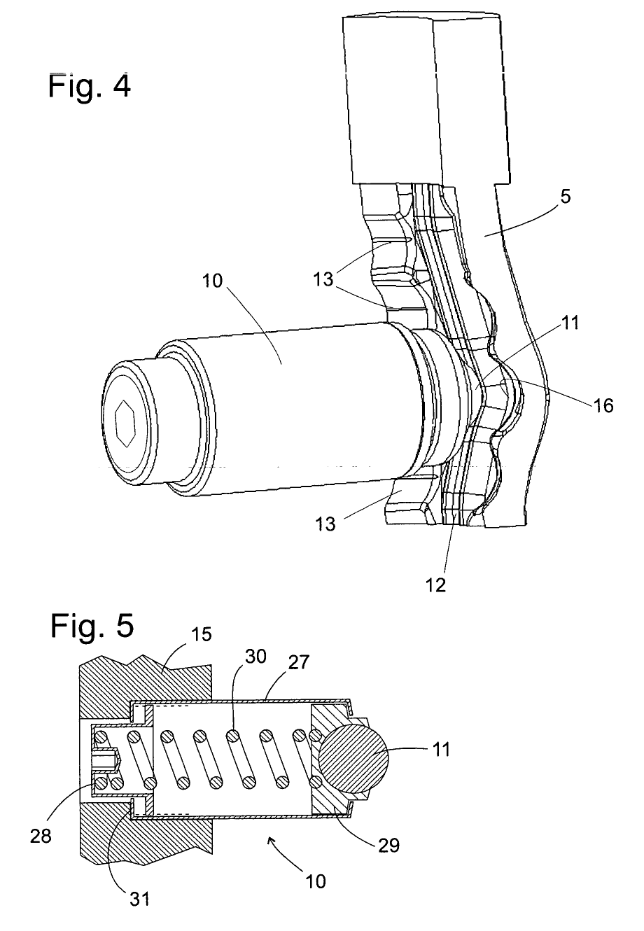

FIG. 4 shows a detail of the assembly from FIG. 3;

FIG. 5 shows a section through the spring capsule from FIG. 4;

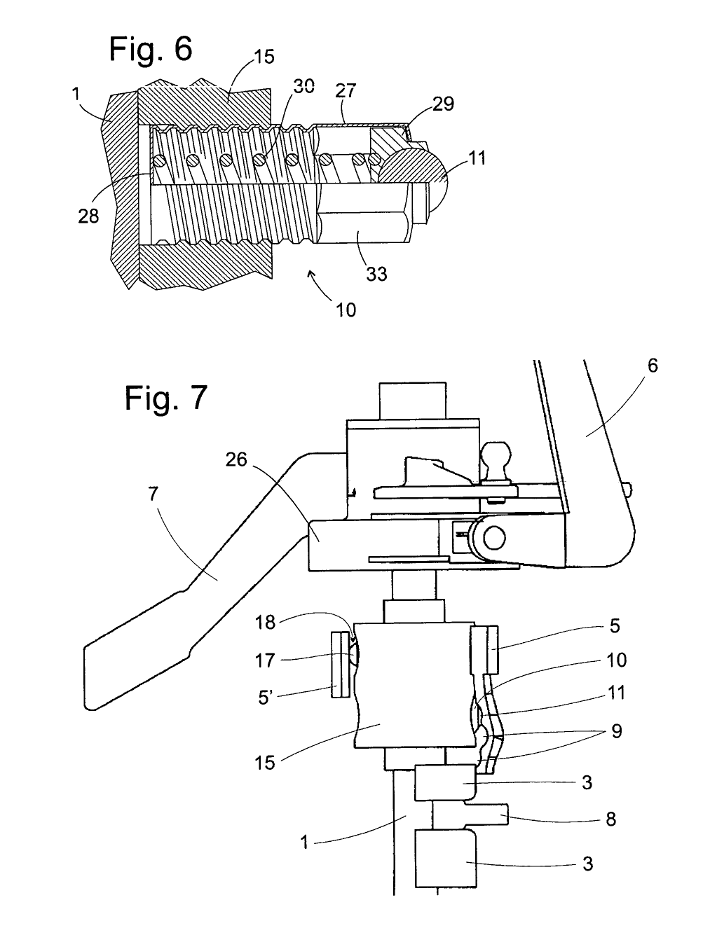

FIG. 6 shows a section through an alternative embodiment of a spring capsule;

FIG. 7 shows a partial view of a shifter shaft-flange-assembly according to a second embodiment;

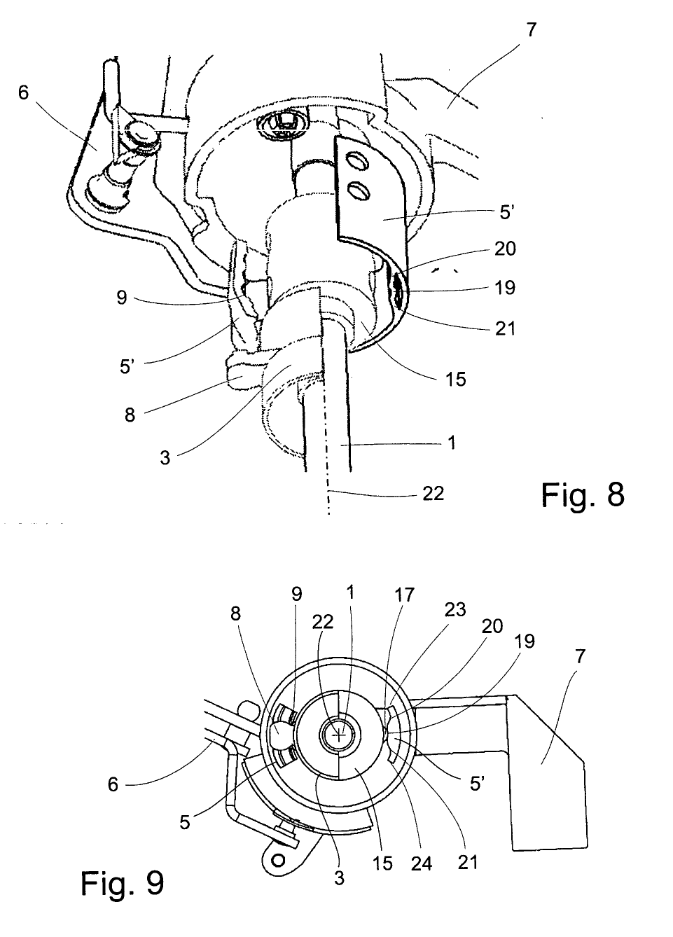

FIG. 8 shows the assembly from FIG. 7, viewed from its side facing the transmission housing; and

FIG. 9 shows the assembly from a viewing direction parallel to the shifter shaft.

FIG. 1 shows in a perspective view a flange 4, which is part of a transmission housing 25 depicted fragmentarily. Accommodated inside the transmission housing 25, below the fragment shown in FIG. 1, is a manual transmission having a plurality of transmission ratios, the exact form whereof, like that of the transmission housing 25 with the exception of the flange 4, is unimportant for the present invention and therefore is not shown and will not be further explained. A shifter shaft 1 is shown in a position inserted through the central opening of the flange 4 partially into the interior of the transmission housing 25. The shifter shaft 1 is connected with a flange 26, toward which it may be rotated and displaced axially, to form an assembly. The flange 26 is provided to be mounted on the flange 4 of the transmission housing 25, e.g. by means of screws 32. In the mounted position of the flange 26, bushings 2, 3 embracing the shaft 1 are held in the interior of the manual transmission housing 25 in order to exactly fix the axis of rotation and translation of the shifter shaft 1. Shift fingers 8 protruding between the bushings 2, 3 act on parts of the manual transmission to drive its shift movements. A movement of the shaft 1 for its part is effect by means of a selector lever 6 and shift lever 7, which act on a head section of the shifter shaft 1 projecting from the transmission housing over an outer side of the flange 26.

The position of the two flanges 4, 26 in relation to one another is fixed, inter alia, by a flat-cylindrical disk 14, which is fastened to the side of the flange 26 facing the transmission housing 25 and when mounted, engages positively in the opening of the flange 4.

The radius of the disk 14 and of the opening in the flange 4 receiving said disk is larger than that of all the other parts of the assembly consisting of the flange 26 and the shaft 1, which engage in the transmission housing 25, so that the latter can be inserted without difficulty through the opening of the flange 4 into the transmission housing 25 and mounted therein.

On the side of the disk 14 facing away from the flange 26, there is attached a skirt 5, which approximately has the form of a centrally widened hollow cylindrical section having its axis parallel to the shaft 1. The skirt 5 can be closed to a sleeve running around the shaft 1; in practice, said skirt extends around the shifter shaft 1 over an angle which is not substantially greater than the freedom of rotational movement of the shifter shaft 1. Groove-like indentations 9 are provided on a surface of the skirt 5 facing the shifter shaft 1. These groove-like indentations 9 are an image of the possible shift paths over which the shifter shaft 1 can move when changing between the different transmission ratios of the manual transmission.

FIG. 2 shows an unrolling of these grooves 9. The plurality of grooves 9 form a pattern which corresponds to a conventional slotted gear-shifting gate. There are a plurality of parallel grooves, also designated as lateral groove 13, and one principal groove 12 perpendicular to the lateral grooves 13 and intersecting these.

FIG. 3 shows on a larger scale the head region of the shifter shaft 1 and the skirt 5. In a ring 15 which is screwed onto the shifter shaft 1 and which is movable therewith, there is inserted a spring capsule 10, having a ball 11 projecting from its end, this ball being radially displaceable against the force of a spring. The ball 11 rolls in the grooves 9 of the skirt 5, the paths which the ball 11 may cover being predefined by the course of the grooves 9 shown in FIG. 2.

FIG. 4 shows, but in enlarged view, merely the spring capsule 10 and a section of the sleeve 5 in their relationship to one another. The ball 11 dips into the grooves and thus specifies the shift movements which the shaft 1 can executes. During these shift movements, the ball 11 rolls along the bottom of the grooves 9 under the pressure of a spring accommodated in the spring capsule 10. When the ball 11 reaches the end of one of the lateral grooves 13, this corresponds to a position of the shaft 1 at which a gear is engaged in the manual transmission; when the ball 11 is located in the principal groove 12, the manual transmission is in neutral.

The grooves 12, 13 have rounded edges at their crossing points so that the balls 11 can change into one of the lateral grooves 13 and back without hindrances or without tilting of the principal groove 12.

As can be seen from FIG. 4, the sleeve 5 has a V-shaped bent profile in the axial direction of the shaft 1 so that one point 16 on the bottom of the principal groove 12 is further removed from the axis of the shaft 1 that the remainder of the principal groove 12. The ball 11 under the pressure of the spring strives toward this when the transmission is shifted into neutral position, i.e. when the ball 11 is located in the principal groove 12. As a result, the transmission is held stably in the neutral position and cannot make an unintentional shift movement from the neutral position, e.g. due to external vibrations.

In a similar manner to that shown in FIG. 4 for the principal groove 12, the auxiliary grooves 13 can also have locally variable radii in relation to the axis of the shaft 1. On the one hand, on at least one central section of their length, they can have increasing radius toward the principal groove to thus assist an automatic movement of the shaft 1 from a position corresponding to one gear to the neutral position before the ball has left the auxiliary groove 13.

On the other hand, on a peripheral section, these grooves can have a radius increasing toward the end of the groove 13 which, as soon as the ball reaches this peripheral section, assists an automatic movement of the shaft into a position corresponding to an engaged gear.

The strength of the force which drives a released shifter shaft into the neutral position or which the driver must apply to bring the shifter shaft 1 into a position corresponding to an engaged gear, depends on the spring force with which the ball 11 is pressed against the bottom of the grooves 9. Since the shifter shaft 1 with the spring capsule 10 and the flange 26 bearing the skirt 5 are connected to form an assembly, the spring force is already effective at this assembly before the shifter shaft 1 is inserted into the transmission housing 25, unlike in a conventional transmission in which corresponding spring capsules are mounted in the transmission housing. Thus, the restoring force exerted by the spring capsule on the shifter shaft 1 can be detected without falsification by a shift resistance of the transmission and optionally set to a desired value.

Setting of the spring force is possible, for example, in the structure of the spring capsule 10 shown in section in FIG. 5. A substantially hollow-cylindrical capsule shell 27 is provided with an internal thread at one end, into which a capsule base 28 is screwed. A compression spring 30 is inserted between the capsule base 28 and a head piece 29 of the spring capsule which holds the ball 11 in a rotationally movable manner, which compression spring drives the head piece 29 away from the capsule base 28 and toward the skirt 5 (not shown in FIG. 5). The pressure exerted by the compression spring 30 on the head piece 29 in a given position of the same, depends on the distance between head piece 29 and capsule base 28, i.e. on how far the capsule base 28 is screwed into the capsule shell 27.

In order to adjust the capsule base 28, it is necessary to remove this from the ring 15; however, since a rearward end of the capsule shell 27 rests on a shoulder 31 of the hole in the ring 15 which receives the spring capsule, the position of the spring capsule 10 is reproducible at any time.

As a consequence of a simplified configuration, capsule shell and capsule base can also form a fixed unit; in this case, it is possible to adjust the force exerted by the spring 30 on the skirt 5 to a desired extent with the aid of plain washers or rings which are inserted between the spring capsule and the bottom of the hole or the shoulder 31.

FIG. 6 shows a further embodiment of a spring capsule 10 which allows adjustment of the force exerted by the ball 11 on the skirt 5 when the spring capsule is mounted. The spring capsule 10 received in a hole in the ring 15 is shown half in section and half in side view. This capsule has a capsule shell 27 which has an external thread in its rear region dipping into the hole, which thread engages in a complementary internal thread of the hole in the ring 15. A hexagon 33 is formed at the front end of the capsule shell 27, which allows the spring capsule 10 mounted in the hole to be turned continuously and thereby adjust its depth of penetration into the hole so that the force with which the compression spring 30 clamped between the base 28 formed in one piece with the capsule shell 27 and the head piece 29, presses the head piece 29 against the shoulder 5, attains a desired value.

FIG. 7 shows a part of an assembly provided for mounting on a flange of the transmission housing, comprising the flange 26 and the shifter shaft 1, according to a second embodiment of the invention. Parts of this embodiment which correspond to the embodiments described with reference to the preceding figures are provided with the same reference numerals and their description is not repeated. The assembly in FIG. 7 has an additional locking element in the form of a spring capsule 18 with a ball 17, which cooperates with further second contours of a skirt 5′. The skirt 5′ can be designed in one piece with the skirt 5 or be firmly mounted independently of this in relation to the flange 26. Like the spring capsule 10, the spring capsule 18 is let into the ring 15 screwed to the shaft 1.

FIGS. 8 and 9 show a partial view of the assembly from FIG. 7, viewed from the direction of the transmission housing and a view of this assembly viewed along the shaft 1 from the inside of the transmission housing, respectively. The spring capsules 10, 18 located axially offset opposite to one another, are omitted in FIG. 8; only the holes accommodating them can be seen in their place. In the diagram in FIG. 9, the spring capsule 10 is concealed behind the shift finger 8. The skirt 5′ located opposite the spring capsule 18 has a central groove 19, which extends parallel to the longitudinal axis 22 of the shaft 1. The position of the groove 19 is selected in the circumferential direction of the skirt 5′ such that the position adopted by the shaft 1 when the ball 17 of the spring capsule 18 is located in the groove 19, corresponds to the neutral state of the manual transmission. When this is the case, the ball 11 is located in the principal groove 12 shown in FIG. 2.

As shown in FIG. 8, the groove 19 is surrounded by two laterally descending ramps 20, 21. When the shaft 1 is rotated about its axis 22, the ball 17 of the spring capsule 18 rolls or slides on one of the ramps 20 or 21 while at the same time, the ball 11 moves along one of the lateral grooves 13 shown in FIG. 2. The spring capsule 18 thereby relaxes. Finally, the ball 17 reaches a rest position on a base 23 or 24 of the ramp 20 or 21. This rest position corresponds in each case to an engaged gear of the transmission. Shifting the transmission into a desired gear is thereby facilitated and the shifting comfort thereby enhanced.

Since the spring capsule 18 sliding on the ramp 20 or 21 exposes the shaft 1 to a torque which drives this to a rest position, a corresponding torque need not be generated by the spring capsule 10 as in the embodiment in FIG. 1. The lateral grooves 13 can thereby run at constant radius and the slope of the principal groove 12 can correspond to the entire freedom of movement of the spring capsule 10. Since the slope of the principal groove 12 is increased compared with the embodiment in FIG. 1, a higher adjusting force in the axial direction of the shaft 1 can be exerted for the same spring constant.

Since the restoring forces effecting an axial displacement or a rotation of the shaft 1 are generated by different spring capsules 10, 18 in this embodiment, by aligning these spring capsules 10, 18, it is possible to adjust these restoring forces independently of one another whereby the simulation of a predefined profile of the shift force to be applied by the driver during a shift process is further facilitated.

As shown in FIG. 7, the spring capsules 10 and 18 are offset by about 180° with respect to one another in the circumferential direction of the shaft 1. The forces exerted on the one hand by the ball 11 of the spring capsule 10 and on the other hand by the ball 17 of the spring capsule 18 on the skirts 5, 5′ therefore cancel each other out at least in part so that only small bearing forces or none at all thereby result between the shaft 1 and the flange 26.

### REFERENCE LIST

1. Shaft
2. Bushing
3. Bushing
4. Flange
5. Skirt
6. Selector lever
7. Shift lever
8. Shift finger
9. Groove
10. Spring capsule
11. Ball
12. Principal groove
13. Lateral groove
14. Disk
15. Ring
16. Point
17. Ball
18. Spring capsule
19. Groove
20. Ramp
21. Ramp
22. Longitudinal axis of shaft 1
23. Base of ramp 20
24. Base of ramp 21
25. Transmission housing
26. Flange
27. Capsule shell
28. Capsule base
29. Head piece
30. Compression spring
31. Shoulder
32. Screw
33. Hexagon

1. A manual transmission for an automobile, comprising:
a transmission housing;
a drive and a driven shaft adapted to coupled to one another in different transmission ratios;
a shifter shaft that is rotatable and axially displaceable along a plurality of predefined paths between a plurality of positions corresponding to the different transmission ratios;
at least one pair of guide elements that predefine the plurality of predefined paths in a cooperating manner, wherein of the first element of the at least one pair of guide elements is attached for movement with the shifter shaft and the second element of the at least one pair of guide elements is attached to a first flange connected to the transmission housing, wherein the first flange is fastened detachable from the transmission housing and is connected to the shifter shaft.

2. The manual transmission according to claim 1, wherein the shifter shaft is guided through the first flange.

3. The manual transmission according to claim 1, wherein the first element comprises a tip and the second element comprises a guide contour scanned by the tip.

4. The manual transmission according to claim 1, wherein the at least one pair of guide elements are pressed toward one another by a spring having an adjustable spring force.

5. The manual transmission according to claim 1, wherein grooves defining the plurality of predefined paths are formed on a guide contour.

6. The manual transmission according to claim 1, wherein the first flange is fastened on a complementary second flange forming a component of the transmission housing and at least one of the first flange and the second flange has a centering body that engages in a complementary recess of the respectively other flange.

7. The manual transmission according to claim 6, wherein the centering body is part of the first flange and the second guide element is attached to the centering body.

8. (canceled)
